(19) United States
(12) Patent Application Publication
(10) Pub. No.: US 2025/0046898 A1
(43) Pub. Date: Feb. 6, 2025

(54) CATHODE RECOVERY APPARATUS

(71) Applicant: HONDA MOTOR CO., LTD., Tokyo (JP)

(72) Inventors: Yohei Takano, Tokyo (JP); Hideki Hashimoto, Tokyo (JP); Kazuo Ishikawa, Saitama (JP)

(21) Appl. No.: 18/786,941

(22) Filed: Jul. 29, 2024

(30) Foreign Application Priority Data
Aug. 4, 2023 (JP) 2023-127689

(51) Int. Cl. H01M 10/54

(52) U.S. Cl. CPC H01M 10/54

(57) ABSTRACT

A cathode recovery apparatus includes separation means that separates an electrode body in a pulled-out state into a cathode and a negative electrode laminate, that includes: a holding section holding an extension region where a first object to be separated, being one of the cathode and the negative electrode laminate, extends further in a pulled-out direction than a second object to be separated, being another one of the cathode and the negative electrode laminate, the holding section holding the extension region so that a head end portion of the second object is included in the electrode body; a pressing section pressing the electrode body from a side of the first object in a thickness direction at upstream of the holding section in the pulled-out direction, and peels off a head end portion of the second object; and a receiving section receiving the peeled off second object.

### INCORPORATION BY REFERENCE

The present application claims priority under 35 U.S.C. § 119 to Japanese Patent Application No. 2023-127689 filed on Aug. 4, 2023. The content of the application is incorporated herein by reference in its entirety.

### BACKGROUND OF THE INVENTION

### Field of the Invention

The present invention relates to a cathode recovery apparatus for separating and recovering a cathode from an electrode wound body in which a cathode and an anode are wound with a separator interposed in between.

### Description of the Related Art

Conventionally, secondary batteries have been widely used that include an electrode wound body in which a cathode and an anode are wound while being insulated from each other via a separator. As such secondary batteries, lead batteries, nickel-cadmium batteries, nickel-hydrogen batteries, lithium ion secondary batteries, and the like are known. In particular, nonaqueous electrolyte secondary batteries such as lithium ion secondary batteries have high energy density, and are therefore expected to be used as in-vehicle power sources for electric vehicles (EVs) and hybrid electric vehicles (HEVs), for example.

Valuables such as cobalt (Co), nickel (Ni), and copper (Cu) are often used in the cathode of the above-mentioned secondary battery. Therefore, from the viewpoint of effective resource utilization, it is important to efficiently recover cathodes from used secondary batteries and reuse (recycle) the valuables contained therein.

In connection with this, an electrode group dismantling apparatus is known that includes: separation means for unrolling and separating a positive electrode, a negative electrode, and a separator from a wound electrode group supported by a supporting means; and winding means for winding up the separated positive electrode, negative electrode and separator, individually (for example, Japanese Patent No. 4754960).

In the above-mentioned conventional technique, it has been necessary for an operator, before operating the electrode group dismantling apparatus, to manually peel off the positive electrode from the laminate of the positive electrode, negative electrode, and separator that form the wound electrode group. Therefore, improvement has been required in terms of efficient recovery of the cathode.

The present invention has been made in view of the current situation, and an object of the present invention is to provide a technique capable of efficiently recovering a cathode from an electrode wound body.

### SUMMARY OF THE INVENTION

To solve the above problem, the cathode recovery apparatus according to aspects of the present invention employs the following configuration. In other words, the gist of the aspects of the present invention is as follows.

[1]

A cathode recovery apparatus that recovers a cathode from an electrode wound body in which a strip-shaped electrode body is wound, the electrode body including the cathode and an anode laminated with a separator interposed in between,
the cathode recovery apparatus including separation means that: separates the electrode body in a pulled-out state into the cathode and a negative electrode laminate including the anode and the separator; and conveys the cathode and the negative electrode laminate, individually, the pulled-out state being a state in which the electrode body is pulled out from the rotatably placed electrode wound body,
wherein the separation means includes:
   a holding section that holds an extension region, the extension region being a region of the electrode body in the pulled-out state, the extension region being a region in which a first object to be separated extends further in a pulled-out direction of the electrode body than a second object to be separated, the first object to be separated being one of the cathode and the negative electrode laminate, the second object to be separated being another one of the cathode and the negative electrode laminate, the holding section holding the extension region so that a head end portion of the second object to be separated is included in the electrode body in the pulled-out state;
   a pressing section that: presses the electrode body in the pulled-out state, from a side of the first object to be separated in a thickness direction, at a position upstream of the holding section in the pulled-out direction; and thereby peels off a head end portion of the second object to be separated from the first object to be separated; and
   a receiving section that receives the second object to be separated that has been peeled off from the first object to be separated.
      [2]

The cathode recovery apparatus according to [1], wherein
the separation means further includes:
   a first touch support section that touches and supports a lamination region of the electrode body in the pulled-out state, in which region the cathode and the negative electrode laminate are laminated, from a side of the second object to be separated in the thickness direction, at a position upstream of the pressing section and a head end portion of the second object to be separated in the pulled-out direction, in a state in which the electrode body in the pulled-out state is pressed by the pressing section; and
   a second touch support section that touches and supports the extension region of the electrode body in the pulled-out state, from a side of the second object to be separated in the thickness direction, at a position downstream of the pressing section and a head end portion of the second object to be separated in the pulled-out direction, in a state in which the electrode body in the pulled-out state is pressed by the pressing section.
      [3]

The cathode recovery apparatus according to [1] or [2], wherein the pressing section presses the electrode body in a state of extending in a width direction of the electrode body and touching the electrode body so as to cross the electrode body.

[4]

The cathode recovery apparatus according to any of [1] to [3], wherein the separation means includes an air injection section that injects compressed air between a head end portion of the second object to be separated and the first object to be separated.

[5]

The cathode recovery apparatus according to any of [1] to [4], wherein the holding section includes a pair of rotating bodies that clamp the first object to be separated from a thickness direction and rotate to send out the first object to be separated.

[6]

The cathode recovery apparatus according to any of [1] to [5], wherein the receiving section includes a pair of rotating bodies that clamp the second object to be separated from a thickness direction and rotate to send out the second object to be separated.

[7]

The cathode recovery apparatus according to any of [1] to [6], wherein the separation means includes an electrode body guide section that: is disposed so as to sandwich the electrode body in the pulled-out state from both sides in a width direction, at a position upstream of the pressing section in the pulled-out direction of the electrode body; and thereby prevents movement of the electrode body in a width direction.

[8]

The cathode recovery apparatus according to any of [1] to [7], wherein the separation means includes a first guide section that: is disposed so as to sandwich the first object to be separated from both sides in a width direction, at a position downstream of the pressing section and upstream of the holding section in a conveyance direction of the first object to be separated; and thereby prevents movement of the first object to be separated in a width direction.

[9]

The cathode recovery apparatus according to any of [1] to [8], wherein the separation means includes a second guide section that: is disposed on the pressing section so as to sandwich the first object to be separated from both sides in a width direction; and thereby prevents movement of the first object to be separated in a width direction.

[10]

The cathode recovery apparatus according to any of [1] to [9], further including peeling means that: injects compressed air between a winding end portion of the electrode body fixed to an outer circumferential surface of the electrode wound body and the outer circumferential surface of the electrode wound body; and thereby peels off the winding end portion from the outer circumferential surface in order to pull out the electrode body from the electrode wound body.

[11]

The cathode recovery apparatus according to [10], wherein the holding section is configured to receive the extension region peeled off from the outer circumferential surface by the peeling means.

[12]

The cathode recovery apparatus according to any of [1] to [11], further including pull-out means that pulls out the electrode body from the electrode wound body,
wherein the pull-out means: lowers the electrode wound body in a state in which the extension region of the electrode body is held and the electrode wound body is rotatable; and thereby pulls out the electrode body from the electrode wound body.

According to the aspects of the present invention, it is possible to efficiently recover the cathode from the electrode wound body.

### BRIEF DESCRIPTION OF THE DRAWINGS

FIG. 1 is an overall perspective view of an electrode wound body;

FIG. 2 is an overall perspective view of the electrode wound body with a part of an electrode body pulled out;

FIG. 3 is a cross-sectional view orthogonal to a width direction of the electrode body;

FIG. 4 is a schematic configuration diagram of a cathode recovery apparatus according to an embodiment;

FIG. 5 is a diagram for describing a wound body holding step;

FIG. 6 is a diagram for describing a winding end portion peeling step;

FIG. 7 is a diagram for describing an extension region holding step;

FIG. 8 is a diagram (1) for describing an electrode body pulling-out step;

FIG. 9 is a diagram (2) for describing the electrode body pulling-out step;

FIG. 10 is a diagram for describing a cathode peeling step;

FIG. 11 is a diagram (1) for describing a cathode receiving step;

FIG. 12 is a diagram (2) for describing the cathode receiving step;

FIG. 13 is a diagram for describing a conveying step; and

FIGS. 14A and 14B are diagrams showing a state in which a peeling wedge presses the electrode body in a pulled-out state.

### DETAILED DESCRIPTION OF THE PREFERRED EMBODIMENT

Hereinafter, an embodiment of the present invention will be described with reference to the drawings. Note that the materials, shapes, relative arrangements, etc. of the components described in the following embodiment are not intended to limit the technical scope of the invention to only those, unless otherwise specified. Individual configurations and combinations thereof, etc. in the embodiment can have additions, omissions, substitutions, and other changes in the configuration as appropriate without departing from the spirit of the present invention.

The following embodiment describes a cathode recovery apparatus that recovers a cathode from an electrode wound body used in a lithium ion secondary battery, as an example. However, objects to which the present invention is to be applied are not limited to electrode wound bodies of lithium ion secondary batteries. The present invention can be applied to any electrode wound body in which a strip-shaped electrode body is wound in which a cathode and an anode are laminated with a separator interposed in between.

### <Electrode Wound Body>

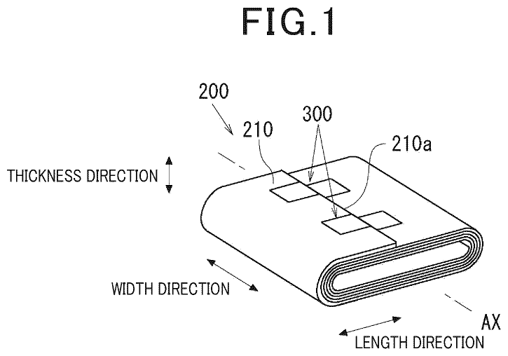

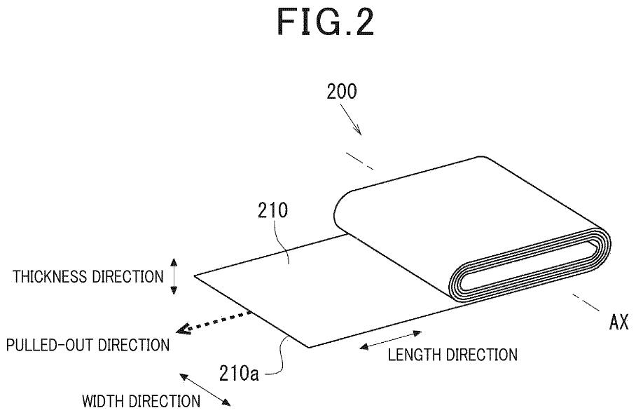

FIG. 1 is an overall perspective view of an electrode wound body 200, which is an example of an object to which a cathode recovery apparatus 100 according to the present embodiment is to be applied. FIG. 2 is an overall perspective view of the electrode wound body 200 with a part of an electrode body 210 pulled out. As shown in FIG. 1, the electrode wound body 200 is formed as a square wound body by winding a strip-shaped electrode body 210 around a winding axis AX and compressing it into a flat shape. Arrows in FIGS. 1 and 2 indicate the “width direction”, “thickness direction”, and “length direction” of the electrode wound body 200 and the electrode body 210. Regarding the electrode wound body 200 and the electrode body 210, the direction parallel to the winding axis AX is defined as the “width direction”, the direction orthogonal to the surface of the electrode body 210 is defined as the “thickness direction”, and the direction orthogonal to the width direction and the thickness direction is defined as the “length direction (extending direction)”.

The electrode wound body 200 according to the present embodiment constitutes, for example, a power generation element of a lithium ion secondary battery mounted in a vehicle such as an electric vehicle (EV) or a hybrid electric vehicle (HEV). This lithium ion secondary battery is, for example, a so-called square battery that includes a square electrode wound body 200, an electrolyte, and a square case as an exterior body accommodating the electrode wound body 200 and the electrolyte. Alternatively, for example, there may be a configuration such that: a lithium ion secondary battery including one electrode wound body 200 is used as a battery cell; a plurality of (for example, 12) battery cells connected in series or parallel are accommodated in a module case to form a battery module; a plurality of (for example, four) battery modules connected in series or parallel are accommodated in a pack case to form a battery pack; and this battery pack is mounted on a vehicle. Note that, in the present embodiment, a so-called square battery is exemplified in which the electrode wound body is compressed into a flat shape, but the present invention can also be applied to a so-called cylindrical (cylindrical tube shaped) battery in which the electrode wound body is cylindrical.

Here, a reference character 210a in FIGS. 1 and 2 denotes a winding end portion of the electrode body 210. The winding end portion 210a of the electrode body 210 is an end portion located on the outer circumferential side of the electrode wound body 200, out of the two end portions of the electrode body 210 in the length direction. As shown in FIG. 1, the winding end portion 210a is fixed to the outer circumferential surface of the electrode body 210 by a winding stopper tape 300, and thereby the electrode wound body 200 is fixed in a wound shape. The winding stopper tape 300 is a sheet-shaped adhesive tape having insulating properties, and is attached to the outer circumferential surface of the electrode wound body 200 across the winding end portion 210a. In the present embodiment, a pair of winding stopper tapes 300, 300 extending in the circumferential direction of the electrode wound body 200 are arranged at intervals in the width direction. Although the material of the winding stopper tape 300 is not particularly limited, polyimide tape can be used as the winding stopper tape 300, for example. The winding end portion 210a is peeled off together with the winding stopper tape 300 from the outer circumferential surface of the electrode wound body 200, thereby making it possible to release the fixed winding of the electrode body 210, pull out the electrode body 210, and unwind the electrode wound body 200 as shown in FIG. 2. Here, the state in which the electrode body 210 is pulled out from the electrode wound body 200 as shown in FIG. 2 is referred to as a “pulled-out state”, and the direction in which the electrode body 210 in the pulled-out state extends is referred to as a “pulled-out direction”. The pulled-out direction coincides with the length direction of the electrode body 210 in the pulled-out state.

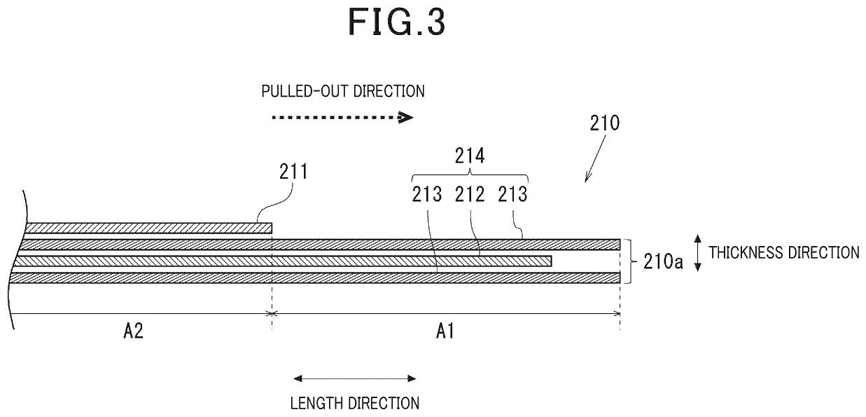

FIG. 3 is a cross-sectional view of the electrode body 210 orthogonal to the width direction. FIG. 3 illustrates a part of the electrode body 210 pulled out from the electrode wound body 200, including the winding end portion 210a. As shown in FIG. 3, the electrode body 210 includes a cathode 211, an anode 212, and a separator 213. A strip-shaped electrode body 210 is formed by laminating the cathode 211 and the anode 212 in the thickness direction with the separator 213 interposed in between.

The cathode 211 is a strip-shaped member that is a metal foil in which a positive electrode active material is supported. The cathode 211 contains valuables. The cathode 211 is formed in such a way that a composite oxide containing lithium and a transition metal is supported as a positive electrode active material in a metal foil. The composite oxide is, for example, nickel-manganese-lithium cobaltate (NMC), nickel-cobalt-lithium aluminate (NCA), lithium titanate (LTO), or lithium manganate (LMO). The metal foil is made of, for example, aluminum, aluminum alloy, or stainless steel.

The anode 212 is a strip-shaped member that is a metal foil in which a negative electrode active material is supported. The anode 212 is formed, for example, in such a way that silicon, silicon oxide, graphite, hard carbon, lithium titanate, LiAl, or the like is supported as a negative electrode active material in a metal foil of, for example, copper, copper alloy, nickel, or stainless steel.

The separator 213 is a strip-shaped member that is interposed between the cathode 211 and the anode 212, and insulates the cathode 211 from the anode 212 by separating them. The separator 213 is made of, for example, a resin material such as polytetrafluoroethylene (PTFE).

As shown in FIG. 3, in the electrode body 210, the anode 212 is sandwiched between a pair (two sheets) of separators 213 from the thickness direction. Hereinafter, the laminate of the anode 212 and the pair of separators 213 will be referred to as a negative electrode laminate, and will be denoted by a reference numeral 214. Note that, in the present embodiment, a negative electrode laminate 214 is constitute d by the anode 212 and the pair of separators 213, but the negative electrode laminate according to the present invention is not limited to this. The negative electrode laminate just needs to be a laminate including an anode and a separator, excluding the cathode, of the electrode body. The electrode body 210 is formed by laminating the cathode 211 and the negative electrode laminate 214 in the thickness direction.

Here, as shown in FIG. 3, the negative electrode laminate 214 extends further than the cathode 211 in the pulled-out direction of the electrode body 210. Therefore, the winding end portion 210a of the electrode body 210 is formed into the negative electrode laminate 214. Hereinafter, as shown in FIG. 3, a region of the electrode body 210 in which the negative electrode laminate 214 extends further in the pulled-out direction than the cathode 211 is referred to as an extension region A1, and the region thereof in which the cathode 211 and the negative electrode laminate 214 are laminated is referred to as a lamination region A2. The extension region A1 is a region from the end portion of the cathode 211 in the pulled-out direction to the end portion of the negative electrode laminate 214 in the pulled-out direction (that is, the winding end portion 210a). In the extension region A1, there is only the negative electrode laminate 214, of the cathode 211 and the negative electrode laminate 214. In the present embodiment, the negative electrode laminate 214 corresponds to an example of a “first object to be separated” according to the present invention, and the cathode 211 corresponds to an example of a “second object to be separated” according to the present invention. However, the present invention is not limited to this. In the present invention, the cathode may extend further in the pulled-out direction than the negative electrode laminate. In that case, the cathode corresponds to the “first object to be separated”, the negative electrode laminate corresponds to the “second object to be separated”, and the region of the electrode body in which the cathode extends further than the negative electrode laminate corresponds to the “extension region.” In other words, in the present invention, one of the cathode and the negative electrode laminate that extends further in the pulled-out direction of the electrode body than the other corresponds to the “first object to be separated.”

### <Cathode Recovery Apparatus>

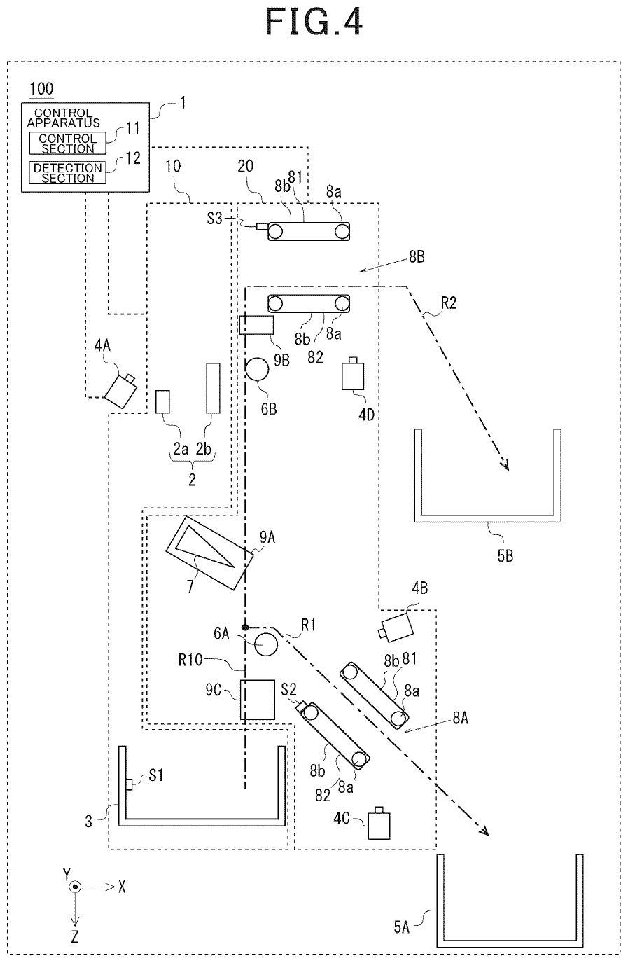

FIG. 4 is a schematic configuration diagram of the cathode recovery apparatus 100 according to the present embodiment. Arrows in FIG. 4 respectively represent the axes of the X-axis direction, Y-axis direction, and Z-axis direction of the cathode recovery apparatus 100. The X-axis direction is a direction orthogonal to the Z-axis direction, and the Y-axis direction is a direction orthogonal to the Z-axis direction and the X-axis direction. The Z-axis direction of the cathode recovery apparatus 100 according to the present embodiment is parallel to the vertical direction (gravitational direction). Therefore, the X-axis direction and the Y-axis direction are parallel to the horizontal direction. Hereinafter, regarding the Z-axis direction, the +side of the Z-axis will be referred to as the “lower side” and the −side of the Z-axis will be referred to as the “upper side.” Furthermore, regarding the X-axis direction, the +side of the X-axis will be referred to as the “front side”, and the −side of the X-axis will be referred to as the “rear side”. However, each direction such as the X-axis direction, Y-axis direction, and Z-axis direction herein merely indicates the relative positional relationship of the members constituting the cathode recovery apparatus 100, and does not limit the present invention.

As shown in FIG. 4, the cathode recovery apparatus 100 includes a control apparatus 1, a wound body clamp 2, a basket 3, air injection nozzles 4A, 4B, 4C, 4D, recovery containers 5A, 5B, guide rollers 6A, 6B, a peeling wedge 7, clamp belts 8A, 8B, guides 9A, 9B, 9C, and sensors S1, S2, S3. Hereinafter, when the air injection nozzles 4A, 4B, 4C, and 4D are described without distinguishing them, they are simply referred to as air injection nozzles 4 collectively. Likewise, when the guide rollers 6A and 6B are described without distinguishing them, they are simply referred to as guide rollers 6 collectively; when the clamp belts 8A and 8B are described without distinguishing them, they are simply referred to as clamp belts 8 collectively; and when the guides 9A, 9B, and 9C are described without distinguishing them, they are simply referred to as guides 9 collectively. As shown in FIG. 4, in the cathode recovery apparatus 100, the wound body clamp 2 and the basket 3 constitute a pull-out apparatus 10 (an example of “pull-out means” according to the present invention). In addition, in the cathode recovery apparatus 100, the air injection nozzles 4B, 4C, 4D, the guide rollers 6, the peeling wedge 7, the clamp belts 8, and the guides 9 constitute a separation apparatus 20 (an example of “separation means” according to the present invention). The pull-out apparatus 10 is an apparatus that pulls out the electrode body 210 from the electrode wound body 200. The separation apparatus 20 separates the electrode body 210 in a pulled-out state, in which state the electrode body 210 is pulled out from the rotatably placed electrode wound body 200, into the cathode 211 and the negative electrode laminate 214, and conveys the cathode 211 and the negative electrode laminate 214, individually.

Furthermore, as shown in FIG. 4, the separation apparatus 20 forms an electrode body conveyance path R10, a cathode conveyance path R1, and an anode conveyance path R2. The electrode body conveyance path R10 is a path along which the electrode body 210 is conveyed before being separated into the cathode 211 and the negative electrode laminate 214, and is formed from the basket 3 to the guide roller 6A. The electrode body conveyance path R10 branches into a cathode conveyance path R1 and an anode conveyance path R2 with the guide roller 6A as a branch point. The cathode conveyance path R1 is a path along which the cathode 211 separated from the electrode body 210 is conveyed, and is formed from the guide roller 6A to the recovery container 5A. The anode conveyance path R2 is a path along which the negative electrode laminate 214 separated from the electrode body 210 is conveyed, and is formed from the guide roller 6A to the recovery container 5B. Each configuration of the cathode recovery apparatus 100 will be described below.

### [Control Apparatus]

The control apparatus 1 includes a processor such as a CPU (central processing unit), an input/output interface, and the like, and executes predetermined programs to control the pull-out apparatus 10, the separation apparatus 20, and the air injection nozzle 4A. The control apparatus 1 includes a control section 11 and a detection section 12 as processing sections. The control section 11 controls the wound body clamp 2, the basket 3, the air injection nozzle 4, the peeling wedge 7, and the clamp belt 8. More specifically, the control section 11 supplies compressed air to the air injection nozzles 4 from a compressor serving as a compressed air supply source, for example, to cause the air injection nozzles 4 to inject compressed air. Furthermore, the control section 11 controls appropriate actuators such as air cylinders and servo motors serving as driving means, for example, to drive the wound body clamp 2, the basket 3, the peeling wedge 7, and the clamp belts 8. The detection section 12 acquires information detected by the sensors S1 to S3 from the respective sensors.

### [Wound Body Clamp]

The wound body clamp 2 has a movable clamp 2a and a fixed clamp 2b arranged side by side in the X-axis direction. In the X-axis direction, the movable clamp 2a is arranged on the rear side (−side of the X-axis) relative to the fixed clamp 2b. The wound body clamp 2 can move the movable clamp 2a in the X-axis direction in response to the control of the control section 11. The wound body clamp 2 changes the distance between the movable clamp 2a and the fixed clamp 2b, thereby switching between clamping and releasing of the electrode wound body 200.

### [Basket]

The basket 3 is formed as a box with an open upper surface, and is a container capable of accommodating the electrode wound body 200. The basket 3 is arranged below the wound body clamp 2 and is movable in the up-down direction (Z-axis direction) in response to the control of the control section 11. The electrode wound body 200 is rotatably arranged in the basket 3.

### [Clamp Belt]

The clamp belts 8 each have a pair of belt rotating bodies 81 and 82 (an example of a “pair of rotating bodies” according to the present invention) arranged side by side in the up-down direction (Z-axis direction). The pair of belt rotating bodies 81 and 82 each include a rotating roller group 8a and an endless conveyor belt 8b wound around the outer circumference of the rotating roller group 8a. The rotating roller group 8a includes a plurality of rotating rollers. The plurality of rotating rollers are provided so that each rotation axis thereof is parallel to the Y-axis direction. The clamp belts 8 are each capable of moving the belt rotating body 81, which is arranged on the upper side of the pair of belt rotating bodies 81 and 82, in the Z-axis direction in response to the control of the control section 11. The clamp belt 8 changes the distance between the pair of belt rotating bodies 81 and 82, and thereby switches between a separating state and a clamping state in which the pair of belt rotating bodies 81 and 82 are closer to each other than in the separating state. Furthermore, the clamp belt 8 is capable of rotating a pair of belt rotating bodies 81 and 82 in response to the control of the control section 11. More specifically, the clamp belt 8 rotates each of rotating rollers of the rotating roller group 8a, thereby rotating the conveyor belts 8b.

The clamp belt 8A is disposed midway along the cathode conveyance path R1. The clamp belt 8A in the separating state can receive the cathode 211 peeled off from the negative electrode laminate 214. The clamp belt 8A switches to the clamping state while receiving the cathode 211, thereby clamping the cathode 211 from the thickness direction. Furthermore, the clamp belt 8A rotates the pair of belt rotating bodies 81 and 82 by the control of the control section 11 while clamping the cathode 211, thereby sending out the cathode 211 to the downstream side in the cathode conveyance path R1. The clamp belt 8A is an example of a “receiving section” according to the present invention. The clamp belt 8B is disposed midway along the anode conveyance path R2. The clamp belt 8B in the separating state can receive the extension region A1 of the electrode body 210 peeled off from the outer circumferential surface of the electrode wound body 200. The clamp belt 8B switches to the clamping state while receiving the extension region A1, thereby clamping the negative electrode laminate 214, which forms the extension region A1, from the thickness direction. Furthermore, the clamp belt 8B rotates the pair of belt rotating bodies 81 and 82 by the control of the control section 11 while clamping the negative electrode laminate 214, thereby sending out the negative electrode laminate 214 to the downstream side of the conveyance path R2. The clamp belt 8B is an example of a “holding section” according to the present invention.

Note that each rotating body according to the present disclosure is not limited to having a conveyor belt, and may be formed of one or a plurality of rotating rollers only. Furthermore, the holding section or the receiving section according to the present invention may be clamp rollers formed of a pair of rotating rollers.

### [Peeling Wedge]

The peeling wedge 7 is disposed at a position upstream of the clamp belt 8B in the anode conveyance path R2. The peeling wedge 7 presses the electrode body 210 in the pulled-out state, thereby peeling off the head end portion of the cathode 211 from the negative electrode laminate 214. The peeling wedge 7 is formed as a wedge-shaped member extending in the Y-axis direction. The cross section of the peeling wedge 7 orthogonal to the Y-axis direction has a substantially triangular shape that narrows toward the front side (+side in the X-axis direction). The peeling wedge 7 moves obliquely so as to be displaced downward (+side in the Z-axis direction) as progress toward the front side (+side in the X-axis direction) in response to the control of the control section 11, and thereby causes the corner of its head end to press the electrode body 210 from the rear side (−side in the X-axis direction). Although the material of the peeling wedge 7 is not particularly limited, it is preferably a material with excellent corrosion resistance from the viewpoint of preventing corrosion due to contact with the electrode, and Teflon (R) can be suitably used, for example. The peeling wedge 7 is an example of a “pressing section” according to the present invention.

### [Guide Roller]

The guide roller 6 is configured to be rotatable, and is provided so that its rotation axis is parallel to the Y-axis direction. The guide roller 6A is disposed on the electrode body conveyance path R10, and its outer circumferential surface touches and supports the electrode body 210 from the front side (+side in the X-axis direction). Rotation of the guide roller 6A guides the cathode 211 and the negative electrode laminate 214 to the downstream side of each conveyance path. In addition, the guide roller 6A forms a branch point between the cathode conveyance path R1 and the anode conveyance path R2. The guide roller 6A is an example of a “first touch support section” according to the present invention. The guide roller 6B is disposed at a position downstream of the peeling wedge 7 and upstream of the clamp belt 8B in the anode conveyance path R2. The guide roller 6B causes its outer circumferential surface to touch and support the extension region A1 (negative electrode laminate 214) from the front side (+side in the X-axis direction). Rotation of the guide roller 6B guides the negative electrode laminate 214 to the downstream side of the conveyance path. The guide roller 6B is an example of a “second touch support section” according to the present invention.

### [Guide]

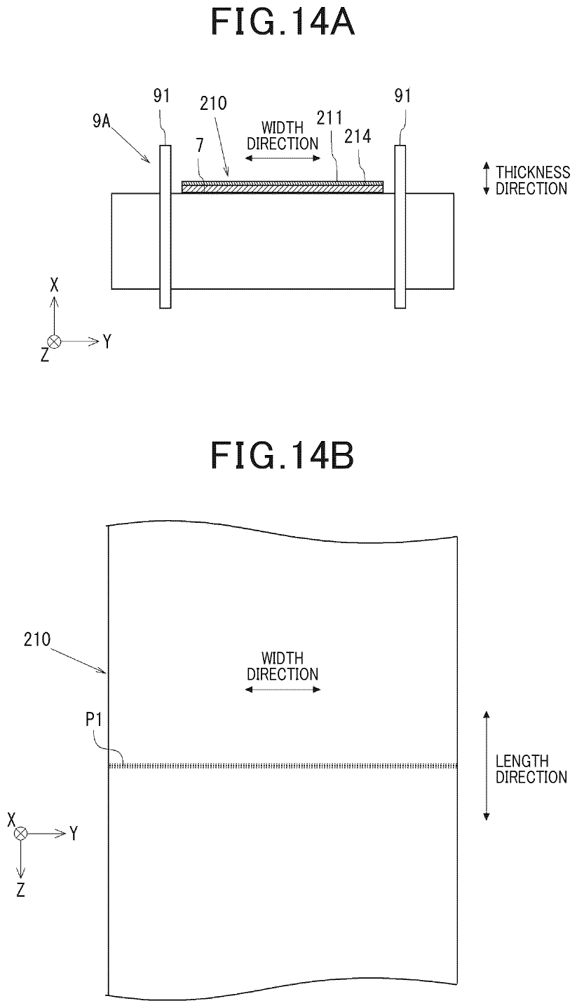

The guides 9 each include a pair of guide plates 91, 91 (see FIG. 14A) that are orthogonal to the Y-axis direction and are spaced apart from each other in the Y-axis direction. The guide 9A is disposed on the peeling wedge 7 so as to sandwich the negative electrode laminate 214, which is separated from the electrode body 210, from both sides in the Y-axis direction. The guide 9A is an example of a “second guide section” according to the present invention. The guide 9B is disposed at a position downstream of the guide roller 6B and upstream of the clamp belt 8B in the anode conveyance path R2 so as to sandwich the negative electrode laminate 214 from both sides in the Y-axis direction. The guide 9B is an example of a “first guide section” according to the present invention. The guide 9C is disposed at a position upstream of the guide roller 6A in the electrode body conveyance path R10 so as to sandwich the electrode body 210 from both sides in the Y-axis direction. The guide 9C is an example of an “electrode body guide section” according to the present invention.

### [Air Injection Nozzle]

The air injection nozzle 4 injects compressed air in response to the control of the control section 11. The air injection nozzle 4A injects compressed air to the electrode wound body 200 held by the wound body clamp 2 to peel off the winding end portion 210a of the electrode body 210, which is fixed to the outer circumferential surface of the electrode wound body 200, from the outer circumferential surface thereof. The air injection nozzle 4A is an example of “peeling means” according to the present invention. The air injection nozzle 4B injects compressed air to the electrode body 210 pressed by the peeling wedge 7 in order to facilitate peeling off the cathode 211 from the negative electrode laminate 214. The air injection nozzle 4B is an example of an “air injection section” according to the present invention. The air injection nozzle 4C injects compressed air to the cathode 211 sent out from the clamp belt 8A so that the cathode 211 does not get caught up in the clamp belt 8A. The air injection nozzle 4D injects compressed air to the negative electrode laminate 214 sent out from the clamp belt 8B so that the negative electrode laminate 214 does not get caught up in the clamp belt 8B.

### [Recovery Container]

The recovery containers 5 are each a container with an open upper surface. The recovery container 5A accommodates the cathode 211 that has been separated by the separation apparatus 20 and conveyed along the cathode conveyance path R1. The recovery container 5B accommodates the negative electrode laminate 214 that has been separated by the separation apparatus 20 and conveyed along the anode conveyance path R2.

### [Sensor]

The sensor S1 detects the presence or absence of the electrode wound body 200 accommodated in the basket 3. The sensor S2 detects the presence or absence of cathode 211 received by clamp belt 8A. The sensor S3 detects the presence or absence of negative electrode laminate 214 received by clamp belt 8B. The information detected by the sensors S1 to S3 is acquired by the detection section 12 of the control apparatus 1. For example, infrared sensors can be used as the sensors S1 to S3, but this is not a limitation, and various sensors can be employed.

### <Operation>

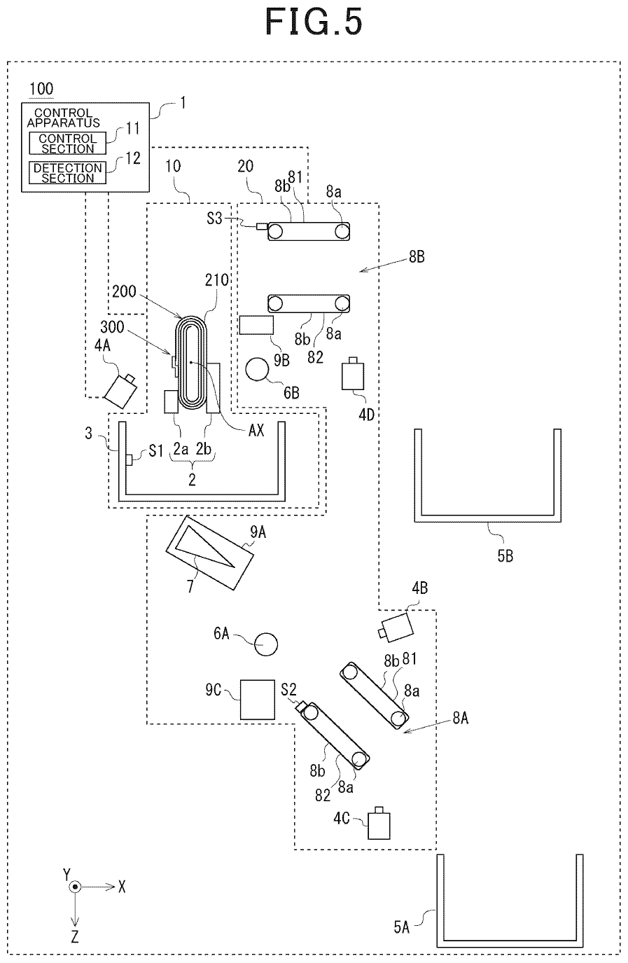

A method of recovering the cathode 211 from a used lithium ion secondary battery includes, for example, a step of opening the square case and taking out the electrode wound body 200 (wound body taking-out step); a step of cutting both end portions in the width direction of the electrode wound body 200 after the wound body taking-out step (cutting step); and a step of recovering the cathode 211 from the electrode wound body 200 with the cathode recovery apparatus 100 after the cutting step (cathode recovery step). Known techniques can be used in the wound body taking-out step and cutting step. FIGS. 5 to 13 are diagrams for describing the operation of the cathode recovery step by the cathode recovery apparatus 100. The cathode recovery step further includes a wound body holding step, a winding end portion peeling step, an extension region holding step, an electrode body pulling-out step, a cathode separating step, and a conveying step. Hereinafter, the operation of the cathode recovery apparatus 100 in the cathode recovery step will be described with reference to the drawings.

### (Wound Body Holding Step)

FIG. 5 is a diagram for describing the wound body holding step. After the cutting step, which is a preceding step, is completed, the electrode wound body 200 is conveyed to the cathode recovery apparatus 100 by a conveyance apparatus (not shown), and is clamped (held) by the wound body clamp 2 as shown in FIG. 5 (wound body holding step). The recovery operation of the cathode 211 with the cathode recovery apparatus 100 is started in a state in which the electrode wound body 200 is clamped by the wound body clamp 2 of the cathode recovery apparatus 100 as shown in FIG. 5 (hereinafter also referred to as the initial state before operation). In the initial state before operation, the electrode wound body 200 is held between the movable clamp 2a and the fixed clamp 2b of the wound body clamp 2 from the X-axis direction, in a posture in which the winding axis AX is parallel to the Y-axis direction. After the above-mentioned conveyance apparatus places the electrode wound body 200 between the movable clamp 2a and the fixed clamp 2b, the wound body clamp 2 moves the movable clamp 2a forward under the control of the control section 11, thereby clamping the electrode wound body 200 and receiving the electrode wound body 200 from the conveyance apparatus. Note that the electrode wound body 200 may be manually placed between the movable clamp 2a and the fixed clamp 2b by an operator, and then clamped by the wound body clamp 2. The wound body clamp 2 presses the movable clamp 2a against the electrode wound body 200 toward a fixed clamp 2b side by the pressure of an air cylinder, for example, thereby maintaining the clamp of the electrode wound body 200 and preventing the electrode wound body 200 from falling off. At this time, the wound body clamp 2 clamps the part excluding the winding end portion 210a and the winding stopper tape 300 so that the winding end portion 210a of the electrode body 210 can be peeled off. In addition, the electrode wound body 200 is positioned so that compressed air from the air injection nozzle 4A can be injected between the winding end portion 210a and the outer circumferential surface of the electrode wound body 200. Here, in the present embodiment, the electrode wound body 200 from which the cathode 211 is to be recovered has a flat shape (square shape). Therefore, it is advantageous that the above-mentioned positioning can be performed more easily than positioning in the case in which the electrode wound body 200 has a cylindrical shape.

### (Winding End Portion Peeling Step)

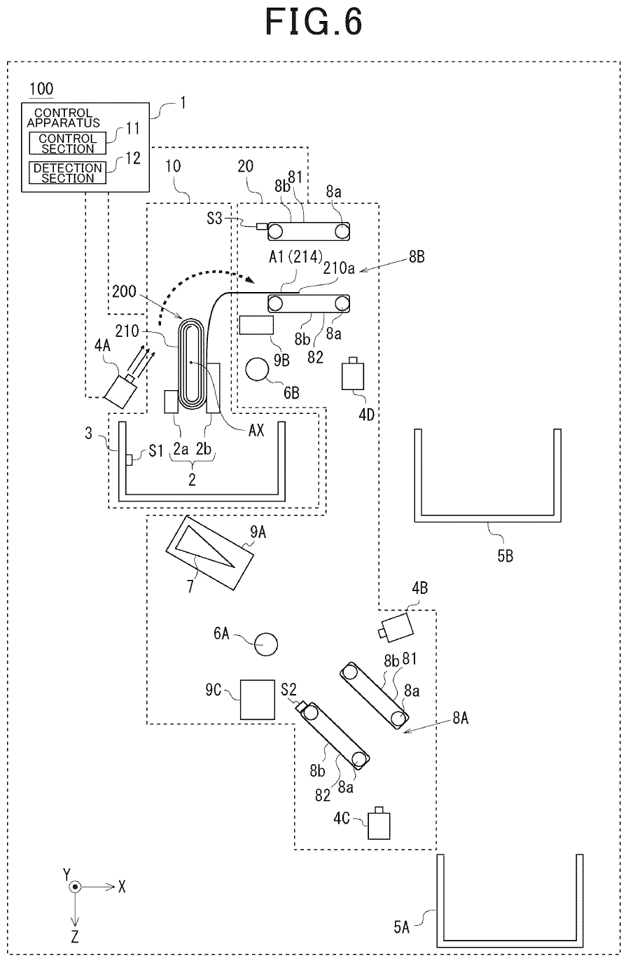

FIG. 6 is a diagram for describing the winding end portion peeling step. Next, as shown in FIG. 6, compressed air is injected from the air injection nozzle 4A by the control of the control section 11, thereby peeling off the winding end portion 210a from the outer circumferential surface (winding end portion peeling step). Compressed air from the air injection nozzle 4A is injected between the winding end portion 210a and the outer circumferential surface of the electrode wound body 200. Then, the winding stopper tape 300 is peeled off from the outer circumferential surface due to the pressure of the compressed air. When the winding stopper tape 300 that has fixed the winding end portion 210a to the outer circumferential surface of the electrode wound body 200 peels off from the outer circumferential surface, the winding end portion 210a also peels off from the outer circumferential surface. Thereby, the extension region A1 of the electrode body 210 is turned over toward a clamp belt 8B side by the pressure of the compressed air. At this time, the clamp belt 8B is in a separating state in which it can receive the extension region A1. Therefore, as shown in FIG. 6, the extension region A1 turned over from the electrode wound body 200 is placed on the belt rotating body 82 which is arranged on the lower side of the pair of belt rotating bodies 81 and 82. Thereby, the extension region A1 is received by the clamp belt 8B.

### (Extension Region Holding Step)

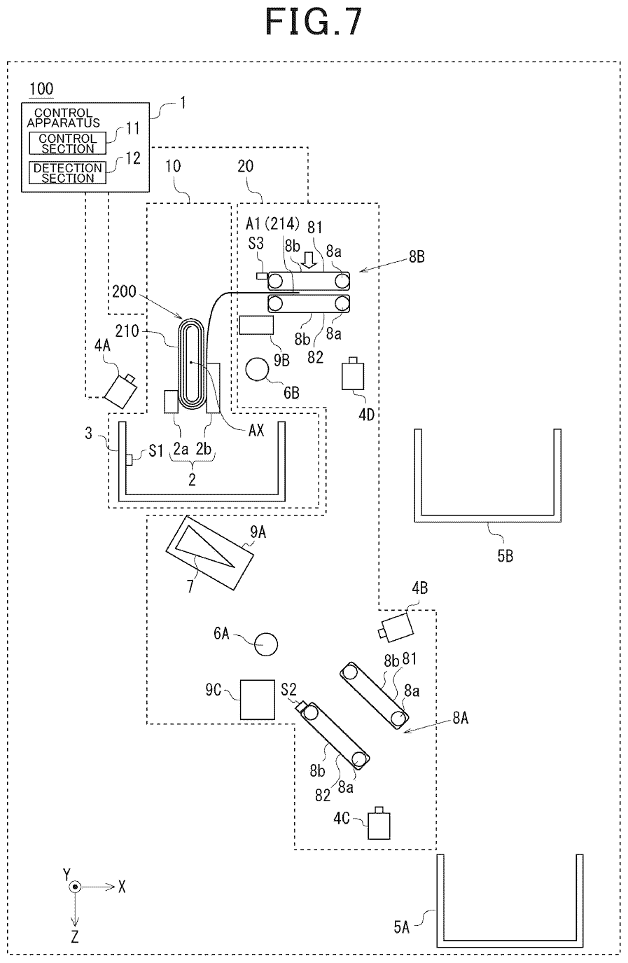

FIG. 7 is a diagram for describing the extension region holding step. Next, as shown in FIG. 7, the clamp belt 8B is brought into a clamping state by the control of the control section 11, thereby clamping the extension region A1 of the electrode body 210 (extension region holding step). When the sensor S3 detects that the extension region A1 (negative electrode laminate 214) has been received by the clamp belt 8B in the separating state, the detection section 12 acquires information indicating the detection result from the sensor S3. The belt rotating body 81 is lowered by the control of the control section 11 based on the detection result, and thereby the clamp belt 8B switches to the clamping state, and the extension region A1 is clamped from the thickness direction. Thereby, the extension region A1 is received by the clamp belt 8B. The clamp belt 8B causes the belt rotating body 81 to press the extension region A1 against a belt rotating body 82 side by the pressure of an air cylinder, for example, thereby maintaining the clamp of the extension region A1 and preventing the extension region A1 from slipping off the clamp belt 8B when the electrode wound body 200, to be described later, lowers.

### (Electrode Body Pulling-Out Step)

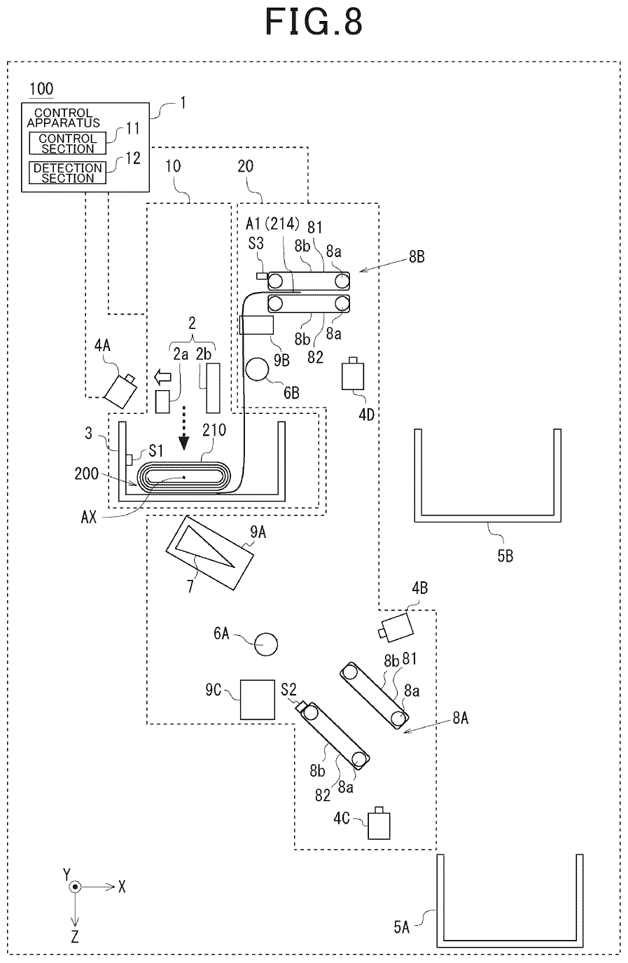

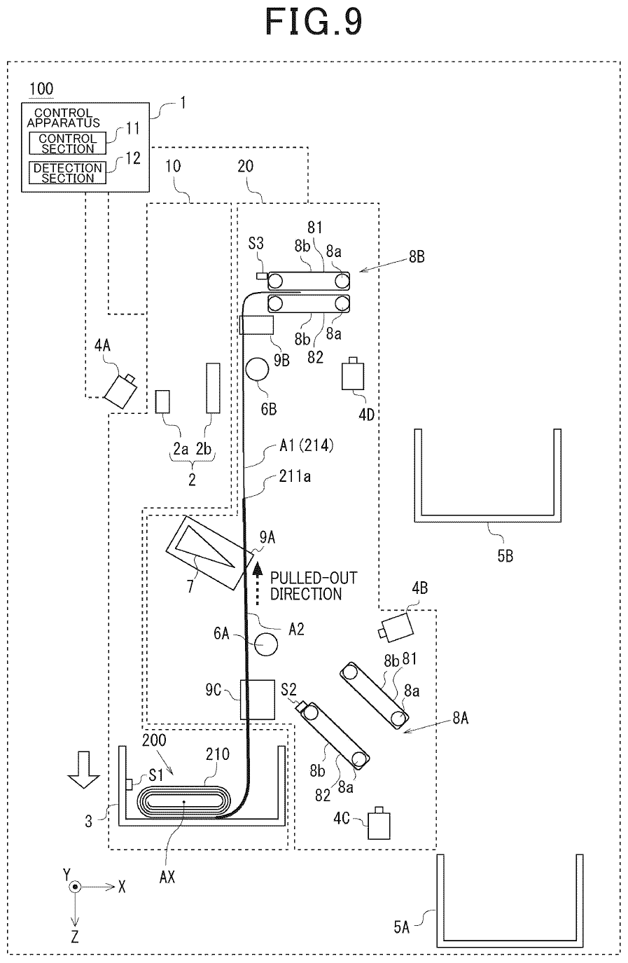

FIGS. 8 and 9 are diagrams for describing the electrode body pulling-out step. Next, as shown in FIGS. 8 and 9, the electrode wound body 200 is lowered with the extension region A1 of the electrode body 210 held by the clamp belt 8B, thereby pulling out the electrode body 210 from the electrode wound body 200 and forming the pulled-out state (electrode body pulling-out step).

In the electrode body pulling-out step, as shown in FIG. 8, the movable clamp 2a of the wound body clamp 2 is first moved backward under the control of the control section 11, thereby releasing the electrode wound body 200 from the wound body clamp 2 and causing the electrode wound body 200 to fall. This causes the electrode wound body 200 to be received in the basket 3 arranged below the wound body clamp 2. When the sensor S1 detects that the electrode wound body 200 is received in the basket 3, the basket 3 is lowered to a predetermined position by the control of the control section 11, as shown in FIG. 9. As a result, the electrode wound body 200 further lowers. The basket 3 is lowered by a predetermined distance, for example, by driving a servo motor. Here, when the electrode wound body 200 falls from the wound body clamp 2 and when the basket 3 lowers, the electrode wound body 200 lowers rotatably around the winding axis AX in a posture in which the winding axis AX is horizontal. At this time, the extension region A1 of the electrode body 210 is held by the clamp belt 8B. Therefore, the electrode wound body 200 lowers while rotating around the winding axis AX so that the electrode body 210 is pulled out. As a result, as shown in FIG. 9, a predetermined length of the electrode body 210 is pulled out from the electrode wound body 200. The clamp belt 8B holds the extension region A1 at a position vertically above the electrode wound body 200, so that the electrode body 210 is kept being pulled out upward from the electrode wound body 200. Therefore, the electrode body 210 in the pulled-out state extends in the Z-axis direction (vertical direction), and its thickness direction coincides with the X-axis direction. In the electrode body 210 in the pulled-out state, the cathode 211 is located on the front side (+side in the X-axis direction), and the negative electrode laminate 214 is located on the rear side (−side in the X-axis direction). The electrode body 210 in the pulled-out state is in a stretched state without any slack.

As shown in FIG. 9, the electrode body 210 is pulled out until at least a part of the lamination region A2 is pulled out from the electrode wound body 200. In other words, the electrode body 210 in the pulled-out state includes a head end portion 211a of the cathode 211. The lowering distance of the electrode wound body 200 with respect to the initial state before operation is set based on the length of the electrode body 210 in the pulled-out state (that is, the length of pulling out the electrode body 210). Note that, in the present embodiment, the electrode body 210 is brought into the pulled-out state by the falling of the electrode wound body 200 and the lowering of the basket 3, but the electrode body 210 may be brought into the pulled-out state only by the falling of the electrode wound body 200. For example, the electrode wound body 200 may be dropped from the wound body clamp 2 to the basket 3 with the basket 3 arranged at a predetermined position in advance shown in FIG. 9. In that case, the next step (cathode separating step) may be started from the sensor S1 detecting that the electrode wound body 200 has been received in the basket 3.

### (Cathode Separating Step)

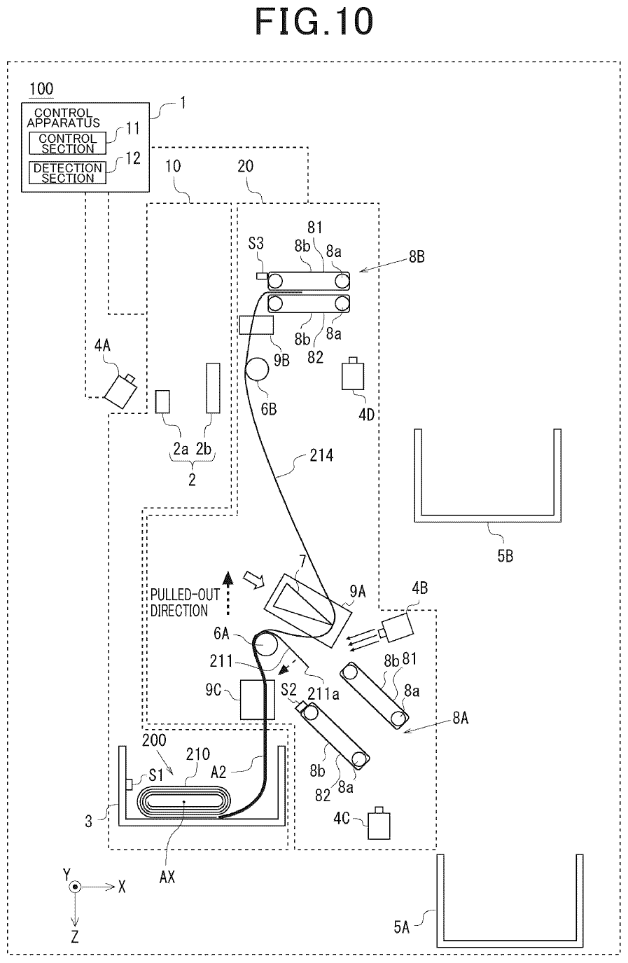

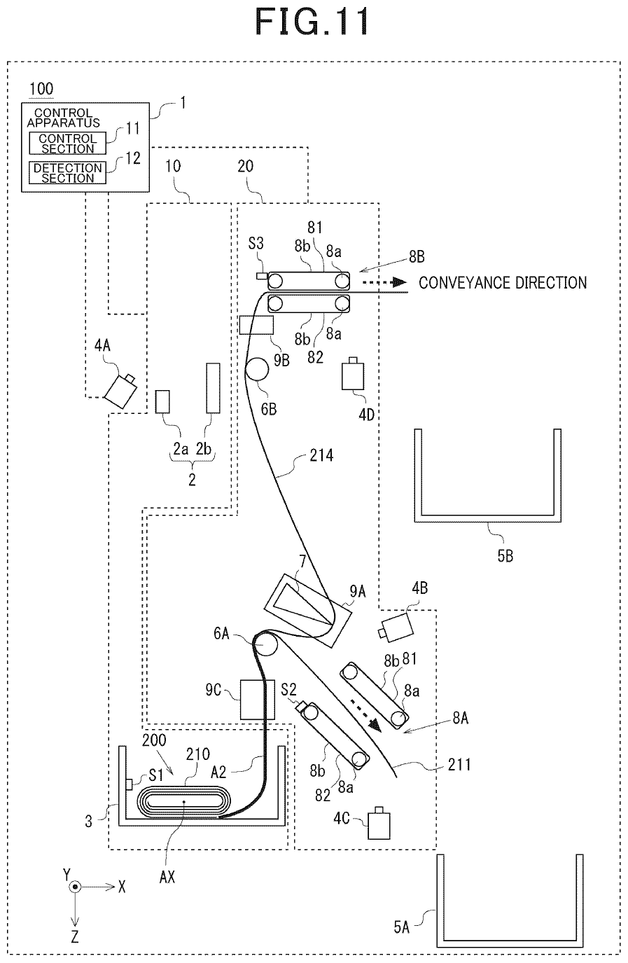

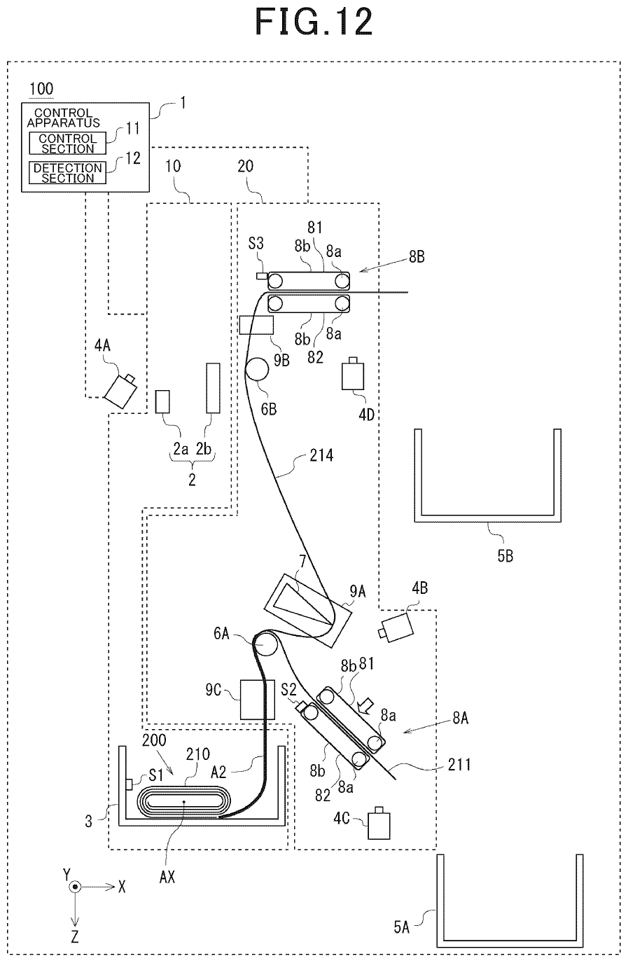

Next, as shown in FIGS. 10 to 12, the electrode body 210 in the pulled-out state is pressed by the peeling wedge 7, and thereby the head end portion of the cathode 211 is peeled off from the negative electrode laminate 214, and the peeled cathode 211 is received by the clamp belt 8A (Cathode separating step). The cathode separating step includes a cathode peeling step and a cathode receiving step. FIG. 10 is a diagram for describing the cathode peeling step, and FIGS. 11 and 12 are diagrams for describing the cathode receiving step.

In the cathode separating step, first, as shown in FIG. 10, the peeling wedge 7 is moved by the control of the control section 11. The peeling wedge 7 moves obliquely so as to be displaced downward as progress toward the front side, and presses the electrode body 210 in the pulled-out state from the rear side (−side in the X-axis direction) (cathode peeling step). The electrode body 210 in the pulled-out state is pressed from a negative electrode laminate 214 side in the thickness direction at a position upstream of the clamp belt 8B in the pulled-out direction. In the present embodiment, the lamination region A2 is pressed by the peeling wedge 7. However, the present invention is not limited to this, and the extension region A1 may be pressed by the peeling wedge 7.

At this time, the negative electrode laminate 214 forming the extension region A1 is held by the clamp belt 8B. Therefore, the negative electrode laminate 214 is pressed by the peeling wedge 7, and thereby is bent into a convex shape toward the front side (a cathode 211 side in the thickness direction). Here, the cathode 211 laminated on the negative electrode laminate 214 is not held by the clamp belt 8B. Therefore, the cathode 211 does not follow the deformation of the negative electrode laminate 214, and forms a gap between itself and the negative electrode laminate 214. As a result, as shown in FIG. 10, the head end portion 211a of the cathode 211 is peeled off from the negative electrode laminate 214.

Here, FIGS. 14A and 14B are diagrams showing a state in which the peeling wedge 7 presses the electrode body 210 in the pulled-out state. FIG. 14A shows a cross section orthogonal to the Z-axis direction (the pulled-out direction of the electrode body 210). FIG. 14B shows the electrode body 210 viewed from the rear side (−side in the X-axis direction). A reference character P1 in FIG. 14B shows a part pressed by the peeling wedge 7 (pressed portion). In other words, a pressed portion P1 is a part with which the head end edge of the peeling wedge 7 comes into contact. As shown in FIG. 14A, the peeling wedge 7 presses the electrode body 210 from the negative electrode laminate 214 side in the thickness direction, in a state of extending in the width direction of the electrode body 210 and touching the electrode body 210 so as to cross the electrode body 210. In this way, since the peeling wedge 7 touches the electrode body 210 across the width direction, the negative electrode laminate 214 is easily bent into a convex shape toward the cathode 211 side. In addition, as shown in FIG. 14B, it is preferable that the pressed portion P1 of the electrode body 210, which is to be pressed by the peeling wedge 7, extends parallel to the width direction. In other words, it is preferable that the peeling wedge 7 have its head end edge that is in line contact with the electrode body 210 so as to be in parallel to the width direction of the electrode body 210 (that is, orthogonal to the length direction of the electrode body 210). Thereby, the pressing force of the peeling wedge 7 is applied evenly in the width direction, allowing the head end portion of the cathode 211 to be peeled off from the negative electrode laminate 214 more reliably. However, the line contact between the peeling wedge 7 and the electrode body 210 may be inclined with respect to the width direction.

Furthermore, in a state in which the electrode body 210 in the pulled-out state is pressed from the negative electrode laminate 214 side by the peeling wedge 7, the guide roller 6A touches and supports the lamination region A2 of the electrode body 210 in the pulled-out state from the cathode 211 side at a position upstream of the peeling wedge 7 and the head end portion 211a of the cathode 211 in the pulled-out direction. In the present embodiment, the guide roller 6A touches and supports the lamination region A2 at a position vertically below the peeling wedge 7 and the head end portion 211a of the cathode 211. In addition, in a state in which the electrode body 210 in the pulled-out state is pressed from the negative electrode laminate 214 side by the peeling wedge 7, the guide roller 6B touches and supports the extension region A1 of the electrode body 210 in the pulled-out state from the cathode 211 side, at a position downstream of the peeling wedge 7 and the head end portion 211a of the cathode 211 in the pulled-out direction. In the present embodiment, the guide roller 6B touches and supports the extension region A1 at a position vertically above the peeling wedge 7 and the head end portion 211a of the cathode 211. According to this, the negative electrode laminate 214 is touched and supported from the side opposite in the thickness direction with respect to the pressure of the peeling wedge 7, at both positions upstream and downstream of the peeling wedge 7 in the pulled-out direction of the electrode body 210. Therefore, the negative electrode laminate 214 is likely to be bent in a convex shape toward the cathode 211 side between the guide roller 6A and the guide roller 6B in the direction in which the electrode body 210 is pulled out. On the other hand, the cathode 211 is not touched and supported from the side opposite in the thickness direction with respect to the pressure of the peeling wedge 7, at a position downstream of the peeling wedge 7 in the pulled-out direction of the electrode body 210. Therefore, the head end portion 211a is likely to peel off from the negative electrode laminate 214.

Furthermore, in the cathode peeling step, the air injection nozzle 4B injects compressed air between the head end portion 211a of the cathode 211 and the negative electrode laminate 214 by the control of the control section 11. According to this, the head end portion 211a is likely to be peeled off from the negative electrode laminate 214 due to the pressure of compressed air.

As shown in FIG. 10, in the pulled-out direction of the electrode body 210, a part of the cathode 211 on the downstream side of the guide roller 6A peels off from the negative electrode laminate 214 so as to hang downward due to the action of gravity. Peeling off the cathode 211 from the negative electrode laminate 214 allows the electrode body 210 to be separated into the cathode 211 and the negative electrode laminate 214.

In the cathode separating step, as shown in FIGS. 11 and 12, the cathode 211 peeled off from the negative electrode laminate 214 is then received by the clamp belt 8A (cathode receiving step). After the electrode body 210 is pressed by the peeling wedge 7, the pair of belt rotating bodies 81 and 82 of the clamp belt 8B are temporarily rotated by the control of the control section 11, and thereby the negative electrode laminate 214 is sent out by a predetermined length to the downstream side of the conveyance path. This causes a predetermined length of the cathode 211 to be pulled out from the electrode wound body 200, and thereby extends the part of the cathode 211 peeled off from the negative electrode laminate 214. At this time, the clamp belt 8A is in a separating state in which it can receive the cathode 211 peeled off from the negative electrode laminate 214. Therefore, as shown in FIG. 11, the cathode 211 peeled off from the negative electrode laminate 214 advances between the pair of belt rotating bodies 81 and 82. Thereby, the cathode 211 is received by the clamp belt 8A. When the sensor S2 detects that the cathode 211 has been received by the clamp belt 8A in the separating state, the detection section 12 acquires information indicating the detection result from the sensor S2. The belt rotating body 81 lowers by the control of the control section 11 based on the detection result, and thereby the clamp belt 8A switches to the clamping state, and the cathode 211 is clamped from the thickness direction as shown in FIG. 12. Thereby, the cathode 211 is received by the clamp belt 8A. The clamp belt 8A maintains the clamp of the cathode 211 for example, with the belt rotating body 81 pressing the cathode 211 against the belt rotating body 82 side by the pressure of an air cylinder.

### (Conveying Step)

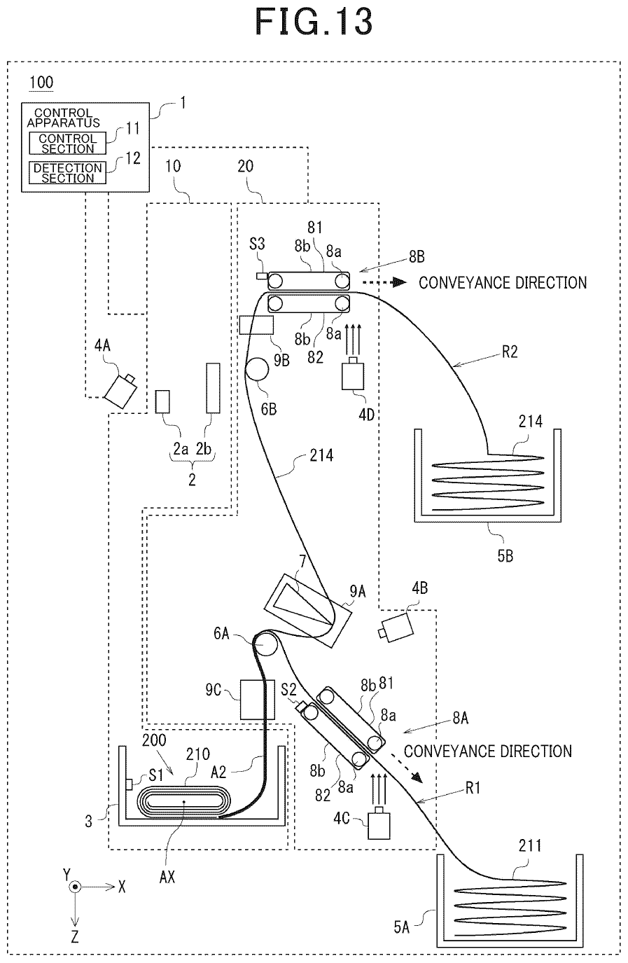

FIG. 13 is a diagram for describing the conveying step. Next, as shown in FIG. 13, the cathode 211 and the anode 212 separated from the electrode body 210 are respectively conveyed to the recovery containers 5 (conveying step). The clamp belt 8A rotates the pair of belt rotating bodies 81 and 82 by the control of the control section 11 while clamping the cathode 211, thereby sending out the cathode 211 to the downstream side of the cathode conveyance path R1. The cathode 211 conveyed by the clamp belt 8A is recovered in a recovery container 5A arranged at the termination of the cathode conveyance path R1. In addition, the clamp belt 8B rotates the pair of belt rotating bodies 81 and 82 under the control of the control section 11 while clamping the negative electrode laminate 214, thereby sending out the negative electrode laminate 214 to the downstream side of the anode conveyance path R2. The negative electrode laminate 214 conveyed by the clamp belt 8B is recovered in the recovery container 5B arranged at the termination of the anode conveyance path R2. Here, while the clamp belt 8A is sending out the cathode 211, compressed air is continuously injected from the air injection nozzle 4C by the control of the control section 11. The air injection nozzle 4C injects compressed air to the cathode 211 from below so that the cathode 211 sent out from the clamp belt 8A does not hang downward due to the action of gravity and does not get caught up in the clamp belt 8A. Likewise, while the clamp belt 8B is sending out the negative electrode laminate 214, compressed air is continuously injected from the air injection nozzle 4D by the control of the control section 11. The air injection nozzle 4D injects compressed air to the negative electrode laminate 214 from below so that the negative electrode laminate 214 sent out from the clamp belt 8B does not hang downward due to the action of gravity and does not get caught up in the clamp belt 8B. In addition, the electrode wound body 200 is arranged in the basket 3 in a rotatable state around the winding axis AX. Therefore, as the cathode 211 and the negative electrode laminate 214 are conveyed, the electrode wound body 200 is unwound while rotating around the winding axis AX within the basket 3.

Here, the electrode body 210 in the pulled-out state is sandwiched from both sides in the width direction by the guide 9C at a position upstream of the peeling wedge 7 in the pulled-out direction, thereby being prevented from moving in the width direction. This prevents meandering of the electrode body 210 before separation in conveyance of the cathode 211 and the negative electrode laminate 214. In addition, the negative electrode laminate 214 separated from the electrode body 210 is sandwiched from both sides in the width direction by guide 9B, at a position downstream of the peeling wedge 7 and upstream of the clamp belt 8B in the direction in which the negative electrode laminate 214 is conveyed (hereinafter also referred to as a conveyance direction), thereby being prevented from moving in the width direction. This prevents meandering of the negative electrode laminate 214 in conveyance of the negative electrode laminate 214. Furthermore, the negative electrode laminate 214 separated from the electrode body 210 is prevented from moving in the width direction by being sandwiched from both sides in the width direction by the guides 9A provided on the peeling wedge 7. Thereby, meandering of the negative electrode laminate 214 is more preferably prevented in conveyance of the negative electrode laminate 214.

When the conveyance of the cathode 211 progresses and the tail end of the cathode 211 passes the clamp belt 8A, the sensor S2 detects that the cathode 211 is not present on the clamp belt 8A. The detection section 12 acquires information indicating the detection result from the sensor S2. The control of the control section 11 based on the detection result stops the rotation of the pair of belt rotating bodies 81 and 82 in the clamp belt 8A and the injection of compressed air by the air injection nozzle 4C. Likewise, when the tail end of the negative electrode laminate 214 passes the clamp belt 8B, the sensor S3 detects that the negative electrode laminate 214 is not present on the clamp belt 8B. The detection section 12 acquires information indicating the detection result from the sensor S3. The control of the control section 11 based on the detection result stops the rotation of the pair of belt rotating bodies 81 and 82 in the clamp belt 8B and the injection of compressed air by the air injection nozzle 4D.

When the electrode body 210 is completely separated into the cathode 211 and the negative electrode laminate 214, and the cathode 211 and the negative electrode laminate 214 are respectively recovered into the recovery containers 5, the cathode recovery step with the cathode recovery apparatus 100 is completed. As described above, use of the cathode recovery apparatus 100 according to the present embodiment allows the cathode 211 to be recovered from the electrode wound body 200 of a used lithium ion secondary battery. The recovered cathode 211 is subjected to known processing, allowing valuables such as cobalt and nickel contained in the cathode 211 to be recovered and reused.

### Action and Effect

As described above, the cathode recovery apparatus 100 according to the present embodiment includes the separation apparatus 20 that: separates the electrode body 210 in a pulled-out state, in which state the electrode body 210 is pulled out from the rotatably placed electrode wound body 200, into the cathode 211 and the negative electrode laminate 214 including the anode 212 and the separator 213; and conveys the cathode 211 and the negative electrode laminate 214, individually. The separation apparatus 20 has a clamp belt 8B that holds the extension region A1 that is the region in which the negative electrode laminate 214 (an example of the first object to be separated) of the electrode body 210 in a pulled-out state extends further in the pulled-out direction of the electrode body 210 than the cathode 211 (an example of the second object to be separated). The clamp belt 8B holds the extension region A1 so that the head end portion of the cathode 211 is included in the electrode body 210 in the pulled-out state. The separation apparatus 20 includes: the peeling wedge 7 that presses the electrode body 210 in the pulled-out state from the negative electrode laminate 214 side in the thickness direction at a position upstream of the clamp belt 8B in the pulled-out direction, and thereby peels off the head end portion of the cathode 211 from the negative electrode laminate 214; and the clamp belt 8A that receives the cathode 211 peeled off from the negative electrode laminate 214.

According to the cathode recovery apparatus 100 constitute d as described above, the cathode 211 can be automatically peeled off from the negative electrode laminate 214 by the operation of the peeling wedge 7. Therefore, the separation of the cathode 211 and the negative electrode laminate 214 is easier compared to the case in which the cathode 211 is manually peeled off from the negative electrode laminate 214. This makes it possible to efficiently recover the cathode 211 from the electrode wound body 200.

In addition, in the present invention, there may be a configuration such that: the cathode is the first object to be separated, and the negative electrode laminate is the second object to be separated; and the cathode extends further than the negative electrode laminate in the pulled-out direction of the electrode body, thereby forming an extension region. In this case, the pressing section presses the electrode body in the pulled-out state from the cathode side in the thickness direction, thereby peeling off the head end portion of the negative electrode laminate from the cathode side. Also in such a case, it is possible to efficiently recover the cathode.

Furthermore, the separation apparatus 20 according to the present embodiment includes guide rollers 6A and 6B. The guide roller 6A touches and supports the lamination region A2 of the electrode body 210 in the pulled-out state from the cathode 211 side in the thickness direction, at a position upstream of the peeling wedge 7 and the head end portion 211a of the cathode 211 in the pulled-out direction, in a state in which the electrode body 210 in the pulled-out state is pressed by the peeling wedge 7. The guide roller 6B touches and supports the extension region A1 of the electrode body 210 in the pulled-out state from the cathode 211 side in the thickness direction, at a position downstream of the peeling wedge 7 and the head end portion 211a of the cathode 211 in the pulled-out direction, in a state in which the electrode body 210 in the pulled-out state is pressed by the peeling wedge 7. This makes it possible to easily peel off the head end portion 211a of the cathode 211 from the negative electrode laminate 214.

Furthermore, the peeling wedge 7 according to the present embodiment presses the electrode body 210 in a state of extending in the width direction of the electrode body 210 and touching the electrode body 210 so as to cross the electrode body 210. This also makes it possible to easily peel off the head end portion 211a of the cathode 211 from the negative electrode laminate 214.

Furthermore, the separation apparatus 20 according to the present embodiment includes an air injection nozzle 4B that injects compressed air between the head end portion of the cathode 211 and the negative electrode laminate 214. This also makes it possible to easily peel off the head end portion 211a of the cathode 211 from the negative electrode laminate 214.

The clamp belt 8B according to the present embodiment includes the pair of belt rotating bodies 81 and 82 that clamp the negative electrode laminate 214 from the thickness direction and rotate to send out the negative electrode laminate 214. This makes it possible to convey the negative electrode laminate 214 separated from the electrode body 210. Note that, in the present embodiment, a common member (the clamp belt 8B) performs: holding the extension region A1 in peeling off the cathode 211; and sending out the negative electrode laminate 214, but the present invention is not limited to this, and separate members may respectively perform holding the extension region and sending out the first object to be separated.

The clamp belt 8A according to the present embodiment includes a pair of rotating bodies that clamp the cathode 211 from the thickness direction and rotate to send out the cathode 211. This makes it possible to convey the cathode 211 separated from the electrode body 210. Note that, in the present embodiment, a common member (the clamp belt 8A) performs: receiving the peeled cathode 211; and sending out the cathode 211, but the present invention is not limited to this, and separate members may respectively perform receiving and sending out the second object to be separated.

Furthermore, the separation apparatus 20 according to the present embodiment has a guide 9C that: is disposed so as to sandwich the electrode body 210 in the pulled-out state from both sides in the width direction, at a position upstream of the peeling wedge 7 in the pulled-out direction of the electrode body 210; and thereby prevents movement of the electrode body 210 in the width direction. This makes it possible to prevent meandering of the electrode body 210 before separation.

Furthermore, the separation apparatus 20 according to the present embodiment has a guide 9B that: is disposed so as to sandwich the negative electrode laminate 214 from both sides in the width direction, at a position downstream of the peeling wedge 7 and upstream of the clamp belt 8B in the conveyance direction of the negative electrode laminate 214; and thereby prevents movement of the negative electrode laminate 214 in the width direction. This makes it possible to prevent meandering of the negative electrode laminate 214.

Furthermore, the separation apparatus 20 according to the present embodiment has a guide 9A that: is disposed on the peeling wedge 7 so as to sandwich the negative electrode laminate 214 from both sides in the width direction; and thereby prevents movement of the negative electrode laminate 214 in the width direction. This also makes it possible to prevent meandering of the negative electrode laminate 214.

In order to pull out the electrode body 210 from the electrode wound body 200, the cathode recovery apparatus 100 according to the present embodiment further includes an air injection nozzle 4A that: injects compressed air between the winding end portion 210a of the electrode body 210 fixed to the outer circumferential surface of the electrode wound body 200 and the outer circumferential surface of the electrode wound body 200; and thereby peels off the winding end portion 210a from the outer circumferential surface. According to this, the operation of the air injection nozzle 4A can automatically peel off the winding end portion 210a of the electrode body 210 from the outer circumferential surface of the electrode wound body 200. This makes it easier to peel off the winding end portion 210a compared to the case in which the winding end portion 210a is peeled off manually. This makes it possible to efficiently recover the cathode 211 from the electrode wound body 200. Note that, in the present embodiment, the electrode wound body 200 has been described in which the winding end portion 210a is fixed by the winding stopper tape 300, the present invention is not limited to this. As long as it is possible to inject compressed air between the winding end portion and the outer circumferential surface of the electrode wound body, the peeling means according to the present invention can also be applied to an electrode wound body whose winding end portion is fixed by means other than a tape.

In addition, the clamp belt 8B according to the present embodiment is configured to receive the extension region A1 of the electrode body 210 that has been peeled off from the outer circumferential surface by the air injection nozzle 4A. This makes it possible to hold the extension region A1 with the clamp belt 8B.

Furthermore, the cathode recovery apparatus 100 according to the present embodiment further includes a pull-out apparatus 10 that pulls out the electrode body 210 from the electrode wound body 200. The pull-out apparatus 10 is constitute d such that: the electrode wound body 200 is lowered in a state in which the extension region A1 of the electrode body 210 is held and the electrode wound body 200 is rotatable; and thereby the electrode body 210 is pulled out from the electrode wound body 200. According to this, the pull-out apparatus 10 makes it possible to automatically pull out the electrode body 210 from the electrode wound body 200. This makes it easier to pull out the electrode body 210 compared to the case in which the electrode body 210 is manually pulled out from the electrode wound body 200. This makes it possible to efficiently recover the cathode 211 from the electrode wound body 200.

Although the embodiments according to the present invention have been described above, each aspect disclosed herein can be combined with any other feature disclosed herein.

### REFERENCE SIGNS LIST

1: control apparatus
2: wound body clamp
3: basket
4A, 4B, 4C, 4D: air injection nozzle
5A, 5B: recovery container
6A, 6B: guide roller
7: peeling wedge
8A, 8B: clamp belt
9A, 9B, 9C: guide
10: pull-out apparatus
20: separation apparatus
100: cathode recovery apparatus
200: electrode wound body
210: electrode body
211: cathode
212: anode
213: separator
214: negative electrode laminate
A1: extension region
A2: lamination region

What is claimed is:

1. A cathode recovery apparatus that recovers a cathode from an electrode wound body in which a strip-shaped electrode body is wound, the electrode body including the cathode and an anode laminated with a separator interposed in between,
the cathode recovery apparatus comprising separation means that: separates the electrode body in a pulled-out state into the cathode and a negative electrode laminate including the anode and the separator; and conveys the cathode and the negative electrode laminate, individually, the pulled-out state being a state in which the electrode body is pulled out from the rotatably placed electrode wound body,
wherein the separation means includes:
a holding section that holds an extension region, the extension region being a region of the electrode body in the pulled-out state, the extension region being a region in which a first object to be separated extends further in a pulled-out direction of the electrode body than a second object to be separated, the first object to be separated being one of the cathode and the negative electrode laminate, the second object to be separated being another one of the cathode and the negative electrode laminate, the holding section holding the extension region so that a head end portion of the second object to be separated is included in the electrode body in the pulled-out state;
a pressing section that: presses the electrode body in the pulled-out state, from a side of the first object to be separated in a thickness direction, at a position upstream of the holding section in the pulled-out direction; and thereby peels off a head end portion of the second object to be separated from the first object to be separated; and
a receiving section that receives the second object to be separated that has been peeled off from the first object to be separated.

2. The cathode recovery apparatus according to claim 1, wherein
the separation means further includes:
a first touch support section that touches and supports a lamination region of the electrode body in the pulled-out state, in which region the cathode and the negative electrode laminate are laminated, from a side of the second object to be separated in the thickness direction, at a position upstream of the pressing section and a head end portion of the second object to be separated in the pulled-out direction, in a state in which the electrode body in the pulled-out state is pressed by the pressing section; and
a second touch support section that touches and supports the extension region of the electrode body in the pulled-out state, from a side of the second object to be separated in the thickness direction, at a position downstream of the pressing section and a head end portion of the second object to be separated in the pulled-out direction, in a state in which the electrode body in the pulled-out state is pressed by the pressing section.

3. The cathode recovery apparatus according to claim 1, wherein the pressing section presses the electrode body in a state of extending in a width direction of the electrode body and touching the electrode body so as to cross the electrode body.

4. The cathode recovery apparatus according to claim 1, wherein the separation means includes an air injection section that injects compressed air between a head end portion of the second object to be separated and the first object to be separated.

5. The cathode recovery apparatus according to claim 1, wherein the holding section includes a pair of rotating bodies that clamp the first object to be separated from a thickness direction and rotate to send out the first object to be separated.

6. The cathode recovery apparatus according to claim 1, wherein the receiving section includes a pair of rotating bodies that clamp the second object to be separated from a thickness direction and rotate to send out the second object to be separated.

7. The cathode recovery apparatus according to claim 1, wherein the separation means includes an electrode body guide section that: is disposed so as to sandwich the electrode body in the pulled-out state from both sides in a width direction, at a position upstream of the pressing section in the pulled-out direction of the electrode body; and thereby prevents movement of the electrode body in a width direction.

8. The cathode recovery apparatus according to claim 1, wherein the separation means includes a first guide section that: is disposed so as to sandwich the first object to be separated from both sides in a width direction, at a position downstream of the pressing section and upstream of the holding section in a conveyance direction of the first object to be separated; and thereby prevents movement of the first object to be separated in a width direction.

9. The cathode recovery apparatus according to claim 1, wherein the separation means includes a second guide section that: is disposed on the pressing section so as to sandwich the first object to be separated from both sides in a width direction; and thereby prevents movement of the first object to be separated in a width direction.

10. The cathode recovery apparatus according to claim 1, further comprising peeling means that: injects compressed air between a winding end portion of the electrode body fixed to an outer circumferential surface of the electrode wound body and the outer circumferential surface of the electrode wound body; and thereby peels off the winding end portion from the outer circumferential surface in order to pull out the electrode body from the electrode wound body.

11. The cathode recovery apparatus according to claim 10, wherein the holding section is configured to receive the extension region peeled off from the outer circumferential surface by the peeling means.

12. The cathode recovery apparatus according to claim 1, further comprising pull-out means that pulls out the electrode body from the electrode wound body,
wherein the pull-out means: lowers the electrode wound body in a state in which the extension region of the electrode body is held and the electrode wound body is rotatable; and thereby pulls out the electrode body from the electrode wound body.
